(19) United States
(12) Patent Application Publication
(10) Pub. No.: US 2026/0133809 A1
(43) Pub. Date: May 14, 2026

(54) MEDIA PROFILE SWITCHING FOR A VEHICLE

(71) Applicant: Rivian IP Holdings, LLC, Irvine, CA (US)

(72) Inventors: Calvin CHING, Richmond (CA); Alex MONTEIRO, San Francisco, CA (US); Mauro HORIE, Vancouver (CA); Yin Lok LAI, Richmond (CA); Chan Wei LIANG, Vancouver (CA)

(21) Appl. No.: 19/373,647

(22) Filed: Oct. 29, 2025

Related U.S. Application Data
(60) Provisional application No. 63/719,047, filed on Nov. 11, 2024.

(51) Int. Cl. G06F 9/445; G06F 9/4401; H04L 9/40

(52) U.S. Cl. CPC G06F 9/4451; G06F 9/4401; H04L 63/0807

(57) ABSTRACT

In certain embodiments, a method for customizing a media provider application executing on an electronic control unit (ECU) of a vehicle comprises receiving, over a local network, a first driver profile selection associated with a first driver; determining, by a processor of the ECU, a first credential folder associated with the first driver, the first credential folder being stored in a memory of the ECU; assigning, by the processor, the first credential folder to a default credential folder for a media provider application, the default credential folder being stored in the memory; and rebooting, by the processor, the media provider application to customize the media provider application for the first driver.

### CROSS-REFERENCE TO RELATED APPLICATIONS

This application claims the benefit of U.S. Provisional Application Ser. No. 63/719,047 (filed on November 11, 2024), the content of which is incorporated by reference herein in its entirety.

### BACKGROUND

The present disclosure relates to vehicles. More particularly, the present disclosure relates to an information and entertainment system for a vehicle.

Vehicles with natively-integrated media provider applications, such as electric vehicles (EVs), allow a user (such as the driver, a passenger, etc.) to sign in to their personal media accounts in order to access the content of their subscriptions over a wireless network, such as music, audio books, podcasts, movies, etc., as well as subscription preferences, recommendations, etc. This process is similar to accessing a user's personal media accounts using a smart phone, a tablet computer, etc.

### BRIEF DESCRIPTION OF THE DRAWINGS

FIG. 1 depicts a diagram of an example electric vehicle (EV), in accordance with embodiments of the present disclosure.

FIG. 2 presents a block diagram of example components of an EV, in accordance with embodiments of the present disclosure.

FIG. 3A presents a diagram of example components of a control system for an EV, in accordance with embodiments of the present disclosure.

FIG. 3B presents a diagram of example components of a control system zone for an EV, in accordance with embodiments of the present disclosure.

FIG. 3C presents a diagram of example components of another control system zone for an EV, in accordance with embodiments of the present disclosure.

FIG. 3D presents a diagram of example components of another control system zone for an EV, in accordance with embodiments of the present disclosure.

FIG. 4 presents a process flow diagram for customizing a media provider application executing on an ECU of an EV, in accordance with embodiments of the present disclosure.

FIG. 5 depicts a flow diagram describing functionality for customizing a media provider application executing on an ECU of an EV, in accordance with certain embodiments of the present disclosure.

### DETAILED DESCRIPTION

Natively-integrated media provider applications typically allow only a single user account to be accessed at any time. Consequently, for vehicles with multiple users (such as multiple drivers), in order to switch accounts for a given media subscription, users typically must log out of one account and log in to another account. Additionally, a soft (or hard) reboot of the operating system or the ECU upon which the natively-integrated media provider application is executing may be required upon switching accounts. These issues result in a high friction interaction each time a driver switch occurs.

Embodiments of the present disclosure advantageously link each user's personal media accounts to their driver profile. After linking a media account, anytime a specific driver profile is activated in the vehicle, any linked media accounts will also be automatically available to the driver without any further action by the driver, such as signing out another user or signing in to their own account.

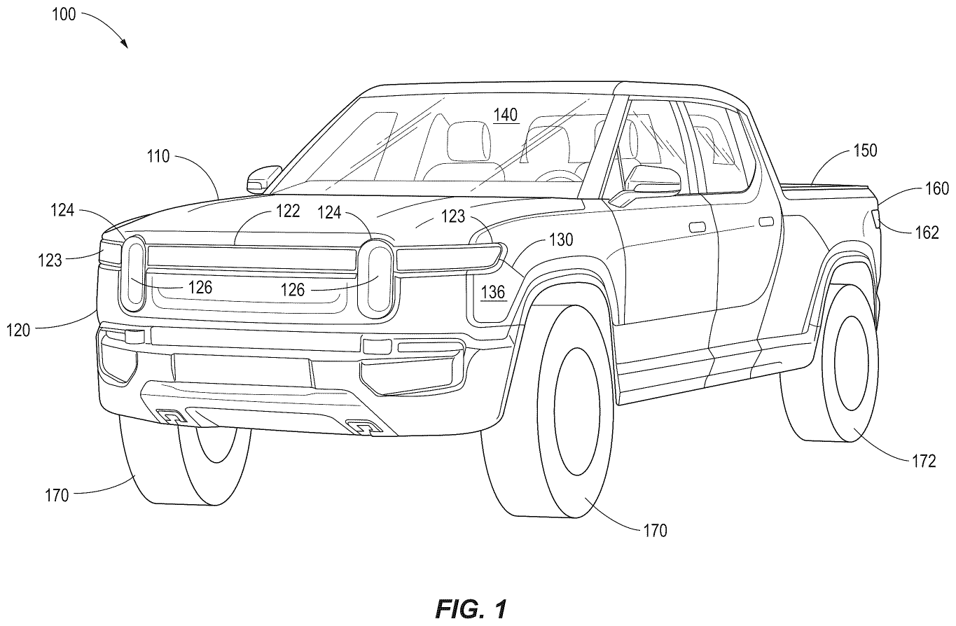

FIG. 1 depicts a diagram of an example electric vehicle 100, in accordance with embodiments of the present disclosure. While the electric vehicle 100 is used to discuss certain aspects of the present disclosure, the principles described herein may be applied to any type of vehicle with an information and entertainment (or infotainment) system.

Electric vehicle 100 includes, inter alia, a frame and body 110, an electrical power storage and distribution system, a propulsion system, a suspension system, a steering system, a control system, auxiliary and accessory systems (such as thermal management, lighting, wireless communications, navigation, etc.), etc.

Generally, body 110 may be directly or indirectly mounted to a frame (i.e., body-on-frame construction), or body 110 may be formed integrally with a frame (i.e., unibody construction). Body 110 includes, inter alia, front end 120, front light bar 122, front turn lights 123, stadium light rings 124, headlights 126, charging port 130 with charging port cover 136 concealing charging connector socket, driver/passenger compartment or cabin 140, bed 150, rear end 160 with rear taillights 162, a rear light bar, etc. Electric vehicle 100 may be a pickup truck, a sport utility vehicle (SUV) in which bed 150 is replaced by an extension of cabin 140, or a sedan in which bed 150 is replaced by a trunk. In certain embodiments, electric vehicle may be an electric delivery vehicle, an electric cargo van, etc.

The propulsion system may include, inter alia, one or more electronic control units (ECUs), one or more electric drive unit (EDUs), front wheels 170, rear wheels 172, etc. The electrical power storage and distribution system may include, inter alia, one or more ECUs, a battery enclosure including a housing containing a traction battery, a vehicle charging subsystem including charging port 130, a high voltage (HV) wiring harness connecting the traction battery to the other HV electrical system components, such as the EDUs, etc.

A single motor EDU may be used to drive front wheels 170 (front wheel drive) or rear wheels 172 (rear wheel drive). Additionally, a single motor EDU may be used to drive front wheels 170 and a single motor EDU may be used to drive rear wheels 172 (four wheel drive). A dual motor EDU may be used to independently drive front wheels 170 (independent front wheel drive) or rear wheels 172 (independent rear wheel drive). Additionally a dual motor EDU may be used to independently drive both front wheels 170 and a dual motor EDU may be used to independently drive both rear wheels 172 (independent four wheel drive).

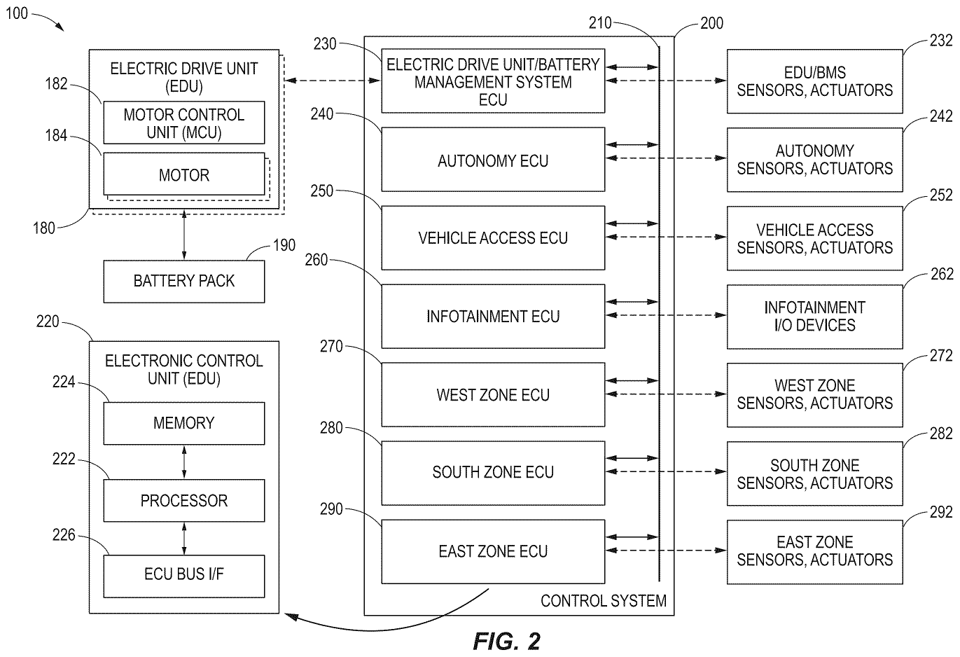

FIG. 2 presents a block diagram of example components of electric vehicle 100, in accordance with embodiments of the present disclosure.

Generally, electric vehicle 100 includes control system 200 that is configured to perform the functions necessary to operate electric vehicle 100. In certain embodiments, control system 200 includes a number of ECUs 220 coupled to ECU bus 210 (also known as a controller area network or CAN bus). Each ECU 220 performs a particular set of functions, and includes, inter alia, one or more processors 222 coupled to memory 224 and ECU bus interface (I/F) 226. Control system 200 may also include one or more wireless network interfaces to provide a wireless communications hub for electric vehicle 100, such as a Bluetooth (BT) or Bluetooth Low Energy (BLE) transmitter/receiver (or transceiver), a WiFi transceiver, a cellular network transceiver, etc.

Generally, control system 200 may be coupled to sensors (such as cameras, radar sensors, ultrasonic sensors, a global positioning system (GPS) receiver, etc.), actuators (such as electric, hydraulic, pneumatic, etc.), input/output (I/O) devices (such as displays, touchscreen displays, mechanical, electrical and electro-mechanical switches, etc.), as well as other components within the propulsion system, the electrical power storage and distribution system, the suspension system, the steering system, the auxiliary and accessory systems, etc., such as one or more EDUs 180 (with a motor control unit 182 and a motor 184), a battery pack 190, etc.

Processor 222 may be a microcontroller unit, a microprocessing unit, a central processing unit (CPU), a programmable logic device (PLD), a complex PLD, a field programmable gate array (FPGA), an application specific integrated circuit (ASIC), etc. Memory 224 may include non-volatile and/or volatile memory, such as read only memory (ROM), random access memory (RAM), static RAM (SRAM), dynamic RAM (DRAM), flash memory, etc. In certain embodiments, control system 200 may include a number of system-on-chips (SoCs). Each SoC may include a number of multi-core processors coupled to a high-speed interconnect and on-chip memory that provide more robust functionality and performance than an ECU 220 with a single processor 222.

In certain embodiments, control system 200 may include an electric drive unit/battery management system (EDU/BMS) ECU 230, an autonomy ECU 240, a vehicle access ECU 250, an infotainment ECU 260, a west zone ECU 270, a south zone ECU 280, and an east zone ECU 290.

The EDU/BMS ECU 230 provides functionality related to the propulsion and electrical power storage and distribution system, and is coupled to EDU/BMS sensors and actuators 232. The autonomy ECU 240 provides functionality related to autonomous vehicle activities, such as sensor data processing, image recognition, etc., and is coupled to autonomous sensors and actuators 242, such as cameras, radars, etc. The vehicle access ECU 250 provides functionality related to accessing and securing the vehicle, such as wireless key fobs, a security system, etc., and is coupled to vehicle access sensors and actuators 252. The infotainment ECU 260 provides functionality related to presenting vehicle information and receiving commands to control the various subsystems (such as HVAC, lighting, etc.), as well as functionality related to various media sources, such as HD and satellite radio, and natively-integrated media provider applications. The infotainment ECU 260 is coupled to the infotainment sensors and actuators 262.

The west zone ECU 270, the south zone ECU 280, and the east zone ECU 290 are also known as zonal controllers, and each zonal controller may control a subset of the sensors and actuators of the electric vehicle 100. The subset of sensors and actuators controlled by each zonal controller may be generally assigned based on location within the electric vehicle 100. For example, the west zone ECU 270 may control the sensors and actuators on a driver side of the electric vehicle 100, the south zone ECU 280 may control the sensors and actuators in a rear portion of the electric vehicle 100, and the east zone ECU 290 may control the sensors and actuators on a passenger side of the electric vehicle 100.

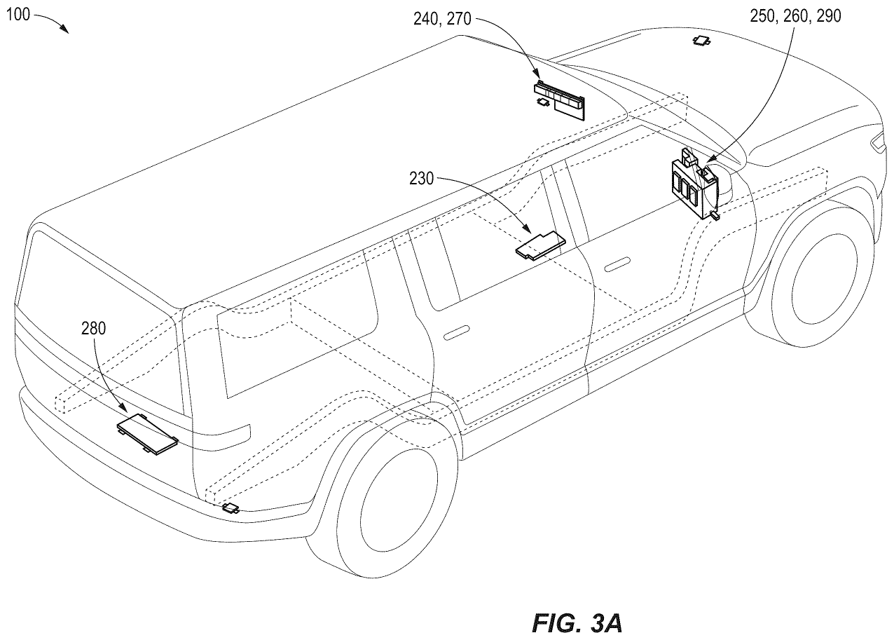

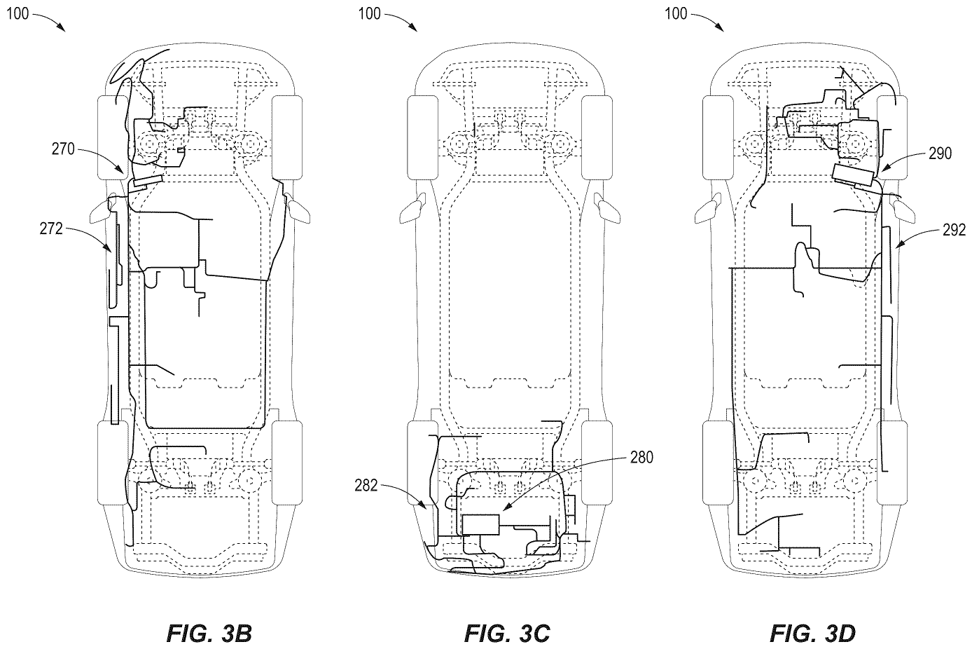

FIG. 3A presents a diagram of example components of the control system 200 for the electric vehicle 100, in accordance with embodiments of the present disclosure.

In certain embodiments, the EDU/BMS ECU 230, the autonomy ECU 240, the vehicle access ECU 250, the infotainment ECU 260, the west zone ECU 270, the south zone ECU 280, and the east zone ECU 290 may be arranged as depicted in FIG. 3A. Other locations for each ECU are also supported.

FIG. 3B presents a diagram of example components of a control system zone for the electric vehicle 100, in accordance with embodiments of the present disclosure.

In certain embodiments, the west zone may include the west zone ECU 270 and the west zone sensors and actuators 272, as depicted in FIG. 3B. Other locations and arrangements for the west zone ECU 270 and the west zone sensors and actuators 272 are also supported.

FIG. 3C presents a diagram of example components of another control system zone for the electric vehicle 100, in accordance with embodiments of the present disclosure.

In certain embodiments, the south zone may include the south zone ECU 280 and the south zone sensors and actuators 282, as depicted in FIG. 3C. Other locations and arrangements for the south zone ECU 280 and the south zone sensors and actuators 282 are also supported.

FIG. 3D presents a diagram of example components of another control system zone for the electric vehicle 100, in accordance with embodiments of the present disclosure.

In certain embodiments, the east zone may include the east zone ECU 290 and the east zone sensors and actuators 292, as depicted in FIG. 3D. Other locations and arrangements for the east zone ECU 290 and the east zone sensors and actuators 292 are also supported.

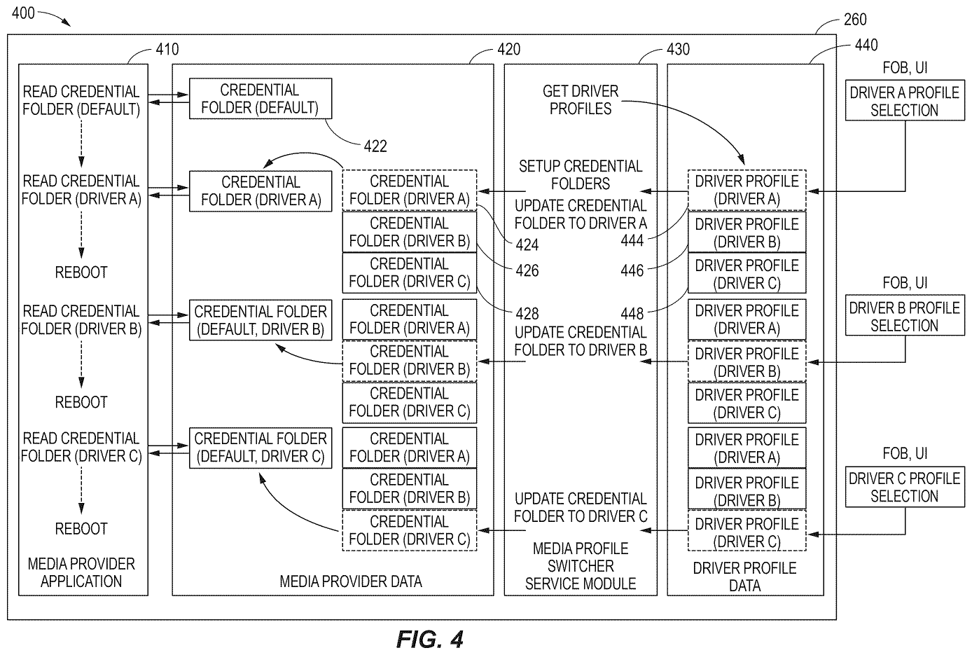

FIG. 4 presents a process flow diagram 400 for customizing a media provider application executing on the infotainment ECU 260 of the electric vehicle 100, in accordance with embodiments of the present disclosure.

In certain embodiments, the processor 222 of the infotainment ECU 260 may execute an operating system (such as the Android Automotive OS, etc.), vehicle applications, natively-integrated applications (such as 3^{rd} party media provider applications, etc.), and other software (such as system service software, etc.) that provide the desired infotainment functionality, while the memory 224 of the infotainment ECU 260 may store the operating system, applications, and other software and their associated data. For example, the software deployed on the infotainment ECU 260 may include, inter alia, one or more system service modules that support certain infotainment functionality, as well as media provider applications that are executable by the operating system (such as Android media streaming applications, etc.).

In certain embodiments, the processor 222 may execute a media provider application 410 that stores media provider data 420 in the memory 224. Generally, the media provider application 410 may communicate with a different ECU over the ECU bus 210 (such as the vehicle access ECU 250, etc.) in order to communicate with a media provider network server over a wireless communication link. The media provider data 420 may include a credential folder 422 that stores authentication information required to authenticate a user of the media provider application 410 to the media provider network server, such as access and refresh tokens issued by the media provider network server, access and refresh tokens issued by other parties, etc. In some embodiments, the authentication information may be encrypted. Only a single user may be authenticated to the media provider network server at a time, for example, because the credential folder 422 only stores a single user's authentication information.

For example, a user may log in to the media provider network server using the media provider application 410, which saves the user's authentication information in the credential folder 422. A new user may then log in to the media provider network server using the media provider application 410, which logs out the previous user, deletes the previous user's authentication information from the credential folder 422, logs in the new user, and saves the new user's authentication information in the credential folder 422. This repeated log in/log out process for each media provider application 410 becomes burdensome when the infotainment ECU 260 hosts multiple media provider applications 410 for multiple users.

Advantageously, the processor 222 may execute a media profile switcher service module 430 that manages the authentication information for each user of the media provider application 410. The media profile switcher service module 430 may be an application that is executed by the processor 222, or, alternatively, the media profile switcher service module 430 may be a component of a larger, system service module.

In certain embodiments, each driver of the electric vehicle 100 may have an associated driver profile which may be managed by a different ECU (such as the vehicle access ECU 250, etc.). A driver profile may include various vehicle-related settings, preferences, etc. that may be configured by the driver, and a driver profile may be selected when a driver approaches the electric vehicle 100 with a key fob, when the driver operates the key fob, when the driver selects a driver profile from a user interface presented on a touchscreen display, etc.

In certain embodiments, the infotainment ECU 260 may receive the driver profile data 440 over the ECU bus 210 from a different ECU, and then store the driver profile data 440 in the memory 224. For example, the driver profile data 440 may include a driver profile 444 associated with driver A, a driver profile 446 associated with driver B, a driver profile 448 associated with driver C, etc. Advantageously, the driver's authentication information for each media provider application 410 may be stored in the driver profile associated with the driver.

In certain embodiments, the infotainment ECU 260 may present one or more selectable media provider applications 410 to the driver in a user interface on a touchscreen display. In response to the selection of one of the media provider applications 410, the processor 222 executes the media provider application 410, which reads the credential folder 422 to access the authentication information stored therein. The media provider application 410 then logs in to the media provider network server using the authentication information, which was provided by the previous user of the media provider application 410. If no authentication information is present in the credential folder 422, the media provider application 410 may prompt the driver to enter his authentication information.

Also in response to the selection of one of the media provider applications 410, the processor 222 executes (accesses, calls, etc.) the media profile switcher service module 430, which may request the driver profile data 440 over the ECU bus 210. The driver profile data 440 also includes a selection of the driver profile, such as the driver profile 444 for driver A.

The media profile switcher service module 430 first parses each driver profile 444, 446, 448 to extract the authentication information for each driver, and then creates an associated credential folder 424, 426, 428 for each driver. The credential folders 424, 426, 428 may have the same format as the credential folder 422. For example, the media profile switcher service module 430 may parse the driver profile 444 to extract the authentication information for driver A, and then create an associated credential folder 424 for driver A. Similarly, the media profile switcher service module 430 may parse the driver profile 446 to extract the authentication information for driver B, and then create an associated credential folder 426 for driver B. And, the media profile switcher service module 430 may parse the driver profile 448 to extract the authentication information for driver C, and then create an associated credential folder 428 for driver C.

In response to receiving the driver profile selection over the ECU bus 210, the media profile switcher service module 430 may determine which credential folder 424, 426, 428 is associated with the selected driver, and then assign the associated credential folder 424, 426, 428 to the credential folder 422. In other words, the media profile switcher service module 430 may update the credential folder 422 to the credential folder associated with selected driver. The media profile switcher service module 430 may then request that the operating system reboot the media provider application 410, which causes the media provider application 410 to read the credential folder 422. Because the credential folder 422 contains the authentication information for the selected driver, the media provider application 410 is now customized for the selected driver.

For example, in response to receiving a driver A profile selection over the ECU bus 210, the media profile switcher service module 430 determines that credential folder 424 is associated with driver A, and then assigns the credential folder 424 to the credential folder 422. Similarly, in response to receiving a driver B profile selection over the ECU bus 210, the media profile switcher service module 430 determines that credential folder 426 is associated with driver B, and then assigns the credential folder 426 to the credential folder 422. And, in response to receiving a driver C profile selection over the ECU bus 210, the media profile switcher service module 430 determines that credential folder 428 is associated with driver C, and then assigns the credential folder 428 to the credential folder 422.

Generally, the credential folder 422 may be known as the default credential folder and may have a default name, and each credential folder 424, 426, 428 may have a different name.

In certain embodiments, assigning the credential folder associated with the selected driver may include deleting the default credential folder, and then renaming the credential folder associated with the selected driver to the default name of the default credential folder. For example, when the selected driver is driver A, the credential folder 424 is renamed to the default name of the credential folder 422. However, when a new driver profile selection is received over the ECU bus 210, an additional step is needed to preserve the authentication information for driver A during the assignment.

For example, after receiving the new driver profile selection associated with driver B over the ECU bus 210, the media profile switcher service module 430 determines that credential folder 426 is associated with driver B, and then assigns the credential folder 426 to the credential folder 422. In this situation, assigning the credential folder 426 may include renaming the credential folder 422 from the default name to the name of the credential folder 424 (which preserve the authentication information for driver A), deleting the credential folder 422, and renaming the credential folder 426 to the default name of the credential folder 422.

In certain other embodiments, assigning the credential folder associated with the selected driver may include deleting the contents of the default credential folder, and copying the contents of the credential folder associated with the selected driver to the default credential folder. For example, when the selected driver is driver A, the contents of the credential folder 422 are deleted, and the contents of the credential folder 424 are copied to the credential folder 422. Similarly, when the selected driver is driver B, the contents of the credential folder 422 are deleted, and the contents of the credential folder 426 are copied to the credential folder 422. And, when the selected driver is driver C, the contents of the credential folder 422 are deleted, and the contents of the credential folder 428 are copied to the credential folder 422.

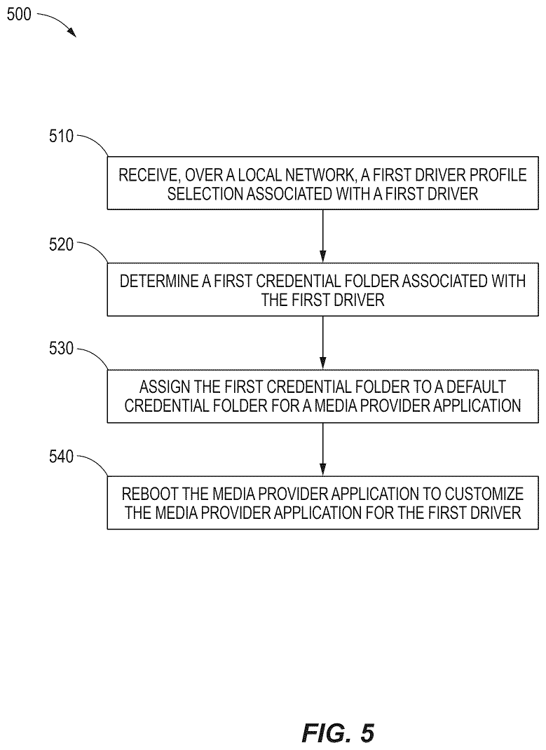

FIG. 5 depicts a flow diagram 500 describing functionality for customizing a media provider application 410 executing on the ECU 260 of the electric vehicle 100, in accordance with certain embodiments of the present disclosure. Generally, the processor 222 of the ECU 260 performs the functionality described by blocks 510, 520, 530, and 540 in cooperation with the memory 224 of the ECU 260 and the ECU bus 210.

At block 510, a first driver profile selection associated with a first driver (e.g., driver A) is received by the ECU 260 over the ECU bus 210.

At block 520, a first credential folder associated with the first driver (e.g., credential folder 424) is determined by the processor 222. The first credential folder is stored in the memory 224.

At block 530, the first credential folder is assigned by the processor 222 to a default credential folder (e.g., credential folder 422) for the media provider application (e.g., media provider application 410). The default credential folder is stored in the memory 224.

At block 540, the media provider application is rebooted by the processor 222 to customize the media provider application for the first driver.

Advantageously, a soft (or hard) reboot of the operating system or the ECU 260 is not required upon switching accounts—only the media provider application needs to be rebooted by the processor 222 in order to customize the media provider application for the first driver. In other words, the media provider application is rebooted by the processor 222 to customize the media provider application for the first driver without rebooting the operating system or the ECU 260.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method for customizing a media provider application executing on an electronic control unit (ECU) of a vehicle, the method comprising:
receiving, over a local network, a first driver profile selection associated with a first driver;
determining, by a processor of an ECU, a first credential folder associated with the first driver, the first credential folder being stored in a memory of the ECU;
assigning, by the processor, the first credential folder to a default credential folder for a media provider application, the default credential folder being stored in the memory; and
rebooting, by the processor, the media provider application to customize the media provider application for the first driver.

2. The method of claim 1, wherein:
the default credential folder has a default name;
the first credential folder has a first name; and
assigning the first credential folder comprises:
deleting the default credential folder from the memory, and
renaming the first credential folder from the first name to the default name.

3. The method of claim 2, further comprising:
receiving, over the local network, a second driver profile selection associated with a second driver;
determining, by the processor, a second credential folder associated with the second driver, the second credential folder having a second name, the second credential folder being stored in the memory;
assigning, by the processor, the second credential folder to the default credential folder; and
rebooting, by the processor, the media provider application to customize the media provider application for the second driver.

4. The method of claim 3, wherein assigning the second credential folder comprises:
renaming the default credential folder from the default name to the first name, and
renaming the second credential folder from the second name to the default name.

5. The method of claim 1, wherein:
assigning the first credential folder comprises:
deleting contents of the default credential folder, and
copying contents of the first credential folder to the default credential folder.

6. The method of claim 5, further comprising:
receiving, over the local network, a second driver profile selection associated with a second driver;
determining, by the processor, a second credential folder associated with the second driver, the second credential folder being stored in the memory;
assigning, by the processor, the second credential folder to the default credential folder; and
rebooting, by the processor, the media provider application to customize the media provider application for the second driver.

7. The method of claim 6, wherein assigning the second credential folder comprises:
deleting contents of the default credential folder; and
copying contents of the second credential folder to the default credential folder.

8. A non-transitory computer-readable medium storing instructions thereon that, when executed by a processor of an electronic control unit (ECU) of a vehicle, cause the processor to:
receive, over a local network, a first driver profile selection associated with a first driver;
determine a first credential folder associated with the first driver, the first credential folder being stored in a memory of the ECU;
assign the first credential folder to a default credential folder for a media provider application, the default credential folder being stored in the memory; and
reboot the media provider application to customize the media provider application for the first driver.

9. The non-transitory computer-readable medium of claim 8, wherein:
the default credential folder has a default name;
the first credential folder has a first name; and
assign the first credential folder comprises:
delete the default credential folder from the memory, and
rename the first credential folder from the first name to the default name.

10. The non-transitory computer-readable medium of claim 9, wherein the instructions are further configured to cause the processor to:
receive, over the local network, a second driver profile selection associated with a second driver;
determine a second credential folder associated with the second driver, the second credential folder having a second name, the second credential folder being stored in the memory;
assign the second credential folder to the default credential folder; and
reboot the media provider application to customize the media provider application for the second driver.

11. The non-transitory computer-readable medium of claim 10, wherein assigning the second credential folder comprises:
renaming the default credential folder from the default name to the first name, and
renaming the second credential folder from the second name to the default name.

12. The non-transitory computer-readable medium of claim 8, wherein:
assigning the first credential folder comprises:
deleting contents of the default credential folder, and
copying contents of the first credential folder to the default credential folder.

13. The non-transitory computer-readable medium of claim 12, wherein the instructions are further configured to cause the processor to:
receive, over the local network, a second driver profile selection associated with a second driver;
determine a second credential folder associated with the second driver, the second credential folder being stored in the memory;
assign the second credential folder to the default credential folder; and
reboot the media provider application to customize the media provider application for the second driver.

14. The non-transitory computer-readable medium of claim 13, wherein assigning the second credential folder comprises:
deleting contents of the default credential folder; and
copying contents of the second credential folder to the default credential folder.

15. A system, comprising:
a memory storing a default credential folder for a media provider application, and a first credential folder associated with a first driver;
a processor coupled to the memory and a local network, the processor configured to:
receive, over the local network, a first driver profile selection associated with the first driver;
determine the first credential folder associated with the first driver;
assign the first credential folder to the default credential folder; and
reboot the media provider application to customize the media provider application for the first driver.

16. The system of claim 15, wherein:
the default credential folder has a default name;
the first credential folder has a first name; and
assigning the first credential folder comprises:
deleting the default credential folder from the memory, and
renaming the first credential folder from the first name to the default name.

17. The system of claim 16, wherein the processor is further configured to:
receive, over the local network, a second driver profile selection associated with a second driver;
determine a second credential folder associated with the second driver, the second credential folder having a second name, the second credential folder being stored in the memory;
assign the second credential folder to the default credential folder; and
reboot the media provider application to customize the media provider application for the second driver.

18. The system of claim 17, wherein assigning the second credential folder comprises:
renaming the default credential folder from the default name to the first name, and renaming the second credential folder from the second name to the default name.

19. The system of claim 15, wherein:
assigning the first credential folder comprises:
deleting contents of the default credential folder, and
copying contents of the first credential folder to the default credential folder.

20. The system of claim 19, wherein the processor is further configured to:
receive, over the local network, a second driver profile selection associated with a second driver;
determine a second credential folder associated with the second driver, the second credential folder being stored in the memory;
assign the second credential folder to the default credential folder comprising:
delete contents of the default credential folder; and
copy contents of the second credential folder to the default credential folder; and
reboot the media provider application to customize the media provider application for the second driver.
